(19) United States
(12) Patent Application Publication
(10) Pub. No.: US 2002/0029273 A1
(43) Pub. Date: Mar. 7, 2002

(54) System and method for calculating concurrent network connections

(76) Inventors: Mark Haroldson, Lynnwood, WA (US); Peter Granger, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 09/875,362

(22) Filed: Jun. 5, 2001

Related U.S. Application Data
(60) Provisional application No. 60/209,498, filed on Jun. 5, 2000.

(51) Int. Cl. G06F 15/173

(52) U.S. Cl. 709/226

(57) ABSTRACT

A system and method for calculating, organizing and storing usage data related to multimedia broadcasts. In one illustrative embodiment, a method of the present invention comprises, receiving a plurality of data records, wherein individual records of the plurality of data records store data attributes that describe a connect time and a disconnect time of a network connection, generating an aggregate change value from the data attributes stored in the plurality of data records, and calculating a number of concurrent network connections within a predetermined time period, wherein the number of concurrent network connections is based on the aggregate change value for individual records having data attributes within the predetermined time period. In other embodiments of the present invention, the system calculates the maximum, minimum, and approximate mean values for concurrent connections.

### CROSS-REFERENCE TO RELATED APPLICATION

This application claims the benefit, under 35 U.S.C. § 119(e) of U.S. Provisional Application No. 60/209,498, filed on Jun. 5, 2000, and entitled “ALGORITHM FOR CALCULATING CONCURRENT CONNECTIONS,” the subject matter of which is expressly incorporated by reference herein.

### FIELD OF THE INVENTION

The present invention relates to computer systems, and in particular, the present invention relates to a computer system and method for calculating, organizing and storing usage data related to multicast data transfers.

### BACKGROUND OF THE INVENTION

In recent years, there has been tremendous growth in the use of multimedia applications on the World Wide Web (“Web”). New developments in multimedia applications have greatly enhanced the quality of viewing experiences for users of the Web, as many now have access to multimedia applications that provide real-time video streams, audio streams, video-on-demand, and many other similar functions. In systems for streaming media over a network such as the Internet, one server may be configured to simultaneously distribute one streaming media file to a plurality of computing devices. In certain instances, to accommodate high demand for specific media, a system may even simultaneously broadcast one streaming video file to thousands of client computers.

Because of the growing interest in streaming media systems and the growing interest in the commercialization thereof, there has been an increased need for broadcast usage information for managing the efficiency of a broadcast server and providing accurate user billing data. In addition, there is an increased need for broadcast usage information for facilitating various studies, such as user interest market studies. Accordingly, there is a need for a system and method for efficiently calculating and storing accurate broadcast usage information.

### SUMMARY OF THE INVENTION

The present invention addresses the above-identified needs by providing a system and method for calculating, organizing and storing usage data related to multimedia broadcasts. In one embodiment, one method of the present invention calculates the number of concurrent network connections associated with multicast streaming media. In another embodiment, the system and method of the present invention provide a data collection algorithm that allows for the generation of a chart that illustrates the number of network connections at specific points of time. In yet another embodiment of the present invention, the system calculates the maximum, minimum, and approximate mean values for concurrent connections during any predetermined time period. Extensions to the methods of the present invention include calculating concurrent connections for a particular server and/or a specific data stream.

In one illustrative embodiment, a method of the present invention comprises, receiving a plurality of data records, wherein individual records of the plurality of data records store data attributes that describe a connect time and a disconnect time of a network connection, generating an aggregate change value for individual records of the plurality of data records, and calculating a number of concurrent network connections within a predetermined time period, wherein the number of concurrent network connections is based on the aggregate change value for individual records having data attributes within the predetermined time period.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a computing environment in which the present invention functions according to one embodiment of the present invention;

FIG. 2 is a block diagram of a client computer for implementing the method of the present invention;

FIG. 3 is a block diagram of a server computer for implementing the method of the present invention; and

FIG. 4 is a flow diagram illustrating a method for determining a plurality of network parameters of a multicast data distribution in accordance with the present invention.

### DETAILED DESCRIPTION OF THE PREFERRED EMBODIMENT

The present invention provides a system and method for calculating, organizing and storing usage data related to multimedia broadcasts. In one embodiment, the present invention provides a system and method for determining the number of concurrent network connections in a client-server multicast data signal. The present invention also provides several methods for generating a minimum and maximum number of concurrent network connections in a predetermined period of time. In addition, one method of the present invention analyzes raw connection data and generates a interval-based data record. The interval-based data record is utilized in one method of the present invention for generating an approximate mean value for a number of concurrent network connections measured over a predetermined time period.

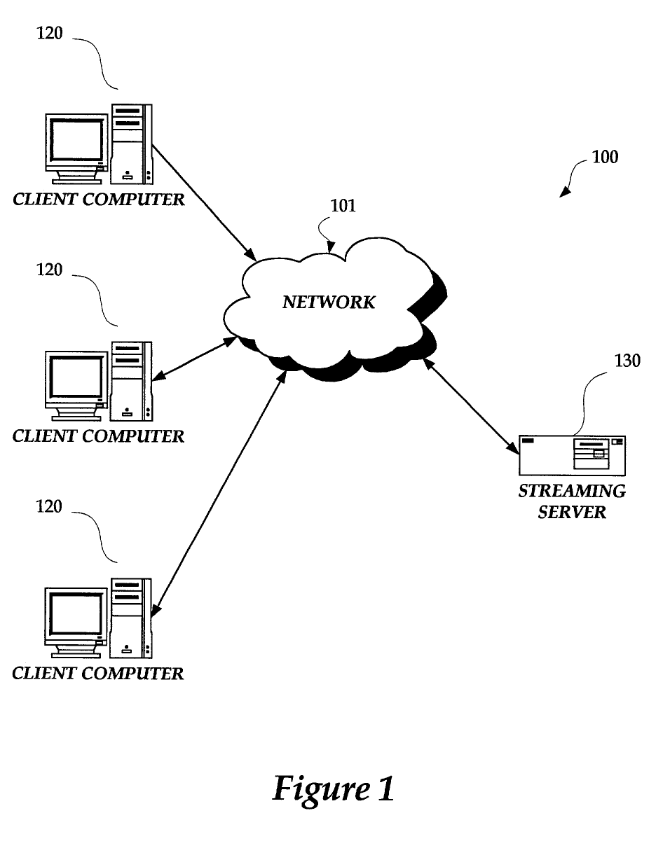

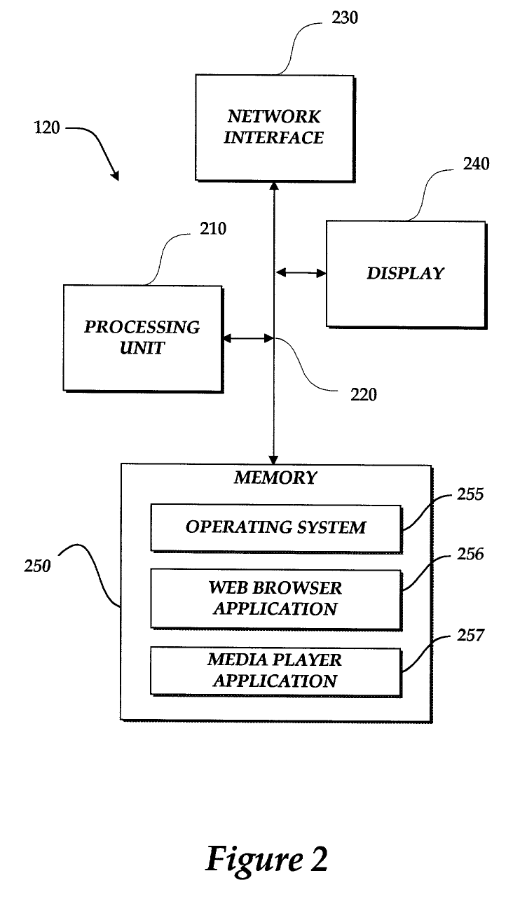

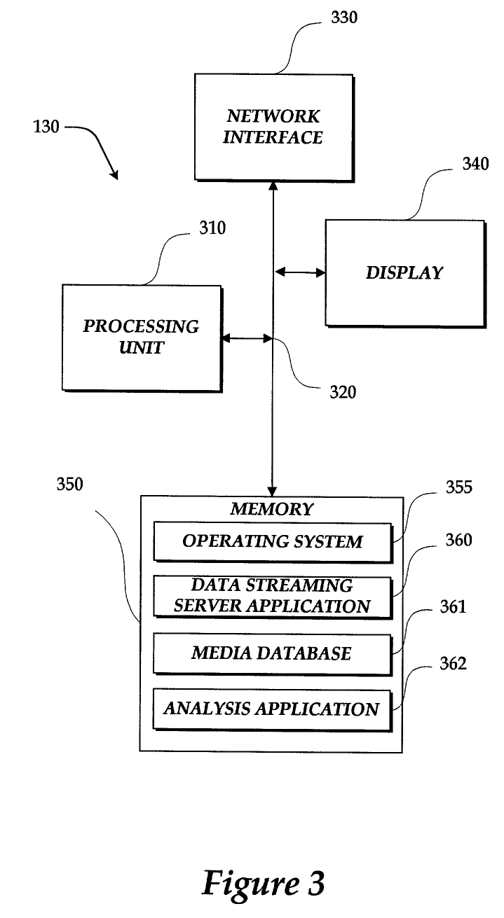

Referring to FIG. 1, the following discussion is intended to provide an exemplary overview of one suitable computing environment in which the invention may be implemented. Generally described, the computing environment may comprise a plurality of client computers 120 and a data streaming server 130. Each computing device depicted in FIG. 1 is configured to electronically communicate via a network 101 such as the Internet. The client computers 120 will be described in greater detail below with reference to FIG. 2 and data streaming server 130 will be described in greater detail below with reference to FIG. 3. It should be appreciated that the illustrative embodiment shown in FIG. 1 is one suitable computing environment for the present invention and that the methods described below may be implemented in any computing environment. For instance, the computing environment of FIG. 1 may be configured on an Intranet, thereby limiting the computing devices to a closed system.

As known to one of ordinary skill in the art, the term “Internet” refers to a collection of networks and routers that use the Internet protocol (“IP”) to communicate with one another. As known to one having ordinary skill in the art, the Internet generally comprises a plurality of LANs and wide-area networks (“WANs”) that are interconnected by routers. Routers are special purpose computers used to interface one LAN or WAN to another. Communication links within the LANs may be twisted pair wire, or coaxial cable, while communication links between the WANs may be optical links. As also known to one having ordinary skill in the art, the World Wide Web (“Web”) is a vast collection of interconnected computing devices that communicate hyper-text documents, audio files, video files, and data streams of audio and/or video files. In some instances, data streams of video files involve multicasting techniques that simultaneously broadcasts one data stream from a data streaming server 130 to a plurality of client computers 120.

Referring now to FIG. 2, an illustrative computer architecture for implementing a client computer 120 in accordance with one aspect of the present invention will be described. Those of ordinary skill in the art will appreciate that the client computer 120 may include many more components than those shown in FIG. 2. However, it is not necessary that all of these generally conventional components be shown in order to disclose an illustrative embodiment for practicing the present invention. As shown in FIG. 2, the client computer 120 includes a network interface 230 for connecting to the network 101. Those of ordinary skill in the art will appreciate that the network interface 230 includes the necessary circuitry for such a connection, and is also constructed for use with the TCP/IP protocol.

The client computer 120 also includes a processing unit 210, a display 240, and a memory 250. The memory 250 generally comprises a random access memory (“RAM”), a read-only memory (“ROM”) and a permanent mass storage device, such as a disk drive. The memory 250 stores the program code necessary for operating the client computer 120 and for generating a graphical user interface (“GUI”) on the display 240. In addition, the memory 250 stores a Web browser application 256, such as NETSCAPE NAVIGATOR® or MICROSOFT INTERNET EXPLORER®. The Web browser application 256 is utilized by a user of the client computer 120 to received and display hyper-text documents and data streams of audio and/or video files. The client computer 120 may also comprise a media player application 257, such as MICROSOFT® WINDOWS MEDIA PLAYER™, for receiving and displaying data streams of audio and/or video files. As will be described in greater detail below, the client computer 120 is configured to receive and display data streams of audio and/or video files from one or more data streaming servers 130. It will be appreciated that these software components may be loaded from a computer-readable medium into memory 250 of the client computer 120 using a drive mechanism associated with the computer-readable medium, such as a floppy, tape or CD-ROM drive (not shown), or via the network interface 230.

Although an illustrative client computer 120 has been described that generally conforms to a conventional general purpose computing device, those of ordinary skill in the art will appreciate that the client computer 120 may comprise any number of devices capable of communicating with a network such as the network 101 or with an information server, such as the data streaming server 130. For example, the client computer 120 may comprise a two-way pager, a cellular phone, a personal data assistant (“PDA”), or the like.

Referring now to FIG. 3, a data streaming server 130 utilized in an actual embodiment of the present invention will be described. In one embodiment of the present invention, the data streaming server 130 is associated with a content provider, publisher, or any other business entity offering streaming data over a network. The data streaming server 130 is configured to provide simultaneous data broadcasts to a plurality of client computers 120, and in some instances, the data streaming server 130 may simultaneously broadcast a data stream to thousands of client computers 120.

Those of ordinary skill in the art will appreciate that the data streaming server 130 includes many more components than those shown in FIG. 3. However, it is not necessary that all of these generally conventional components be shown in order to disclose an illustrative embodiment for practicing the present invention. As shown in FIG. 3, the data streaming server 130 comprises a network interface 330 that is used to electronically communicate with a network such as the Internet. Those of ordinary skill in the art will appreciate that the network interface 330 includes the necessary circuitry for connecting the data streaming server 130 to the network 101, and is constructed for the use with a communication protocol such as the TCP/IP protocol.

The data streaming server 130 also includes a processing unit 310, a display 340, and a mass memory 350, all interconnected along the network interface 330 via a bus 320. The mass memory 350 generally comprises RAM, ROM, and a mass storage device such as a hard disk drive. The mass memory 350 stores the program code necessary for providing data feeds to a plurality of client computers 120. To provide such functionality, the mass memory 350 stores a media database 361 for storing a plurality of video and audio files to be distributed by the data streaming server 130. In addition, the mass memory 350 also comprises an operating system 355 configured to operate and control the functionality of the data streaming server 130, such as Windows NT® from Microsoft Corporation.

The mass memory 350 also stores a data streaming server application 360 for serving and broadcasting the data files in the media database 361. In addition, the mass memory 350 stores an analysis application 362 for implementing methods of the present invention. As known to one of ordinary skill in the art, analysis application 362 may also be stored and executed on a computing device separate from the data streaming server 130. As described below, the methods of the present invention generate a plurality of data parameters from a streaming server usage data record, wherein the methods may be performed on any computing device. It will be appreciated that the aforementioned software components may be loaded from a computer-readable medium into the mass memory350 of the data streaming server 130 using a drive mechanism associated with the computer-readable medium, such as a floppy, tape, or CD-ROM drive (not shown) or via the network interface 330.

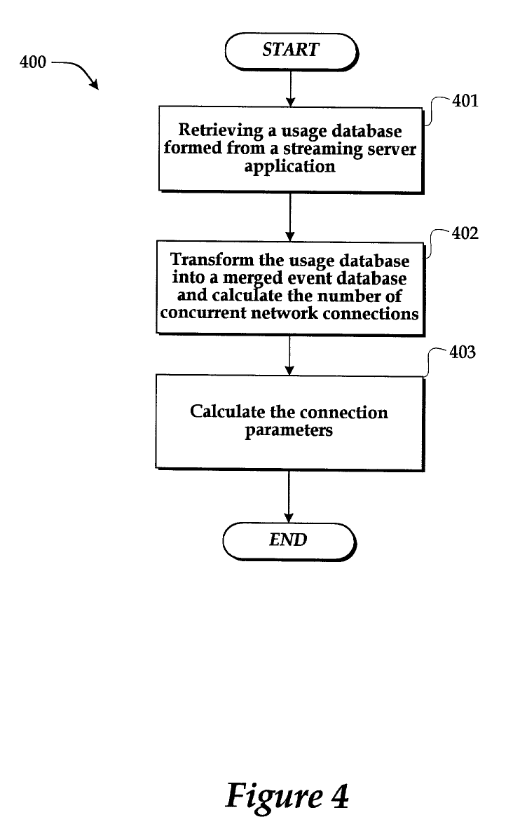

Referring now to FIG. 4, in conjunction with the system illustrated in FIG. 1, an illustrative flow diagram of a concurrency routine 400 for generating a relative event database is shown. Generally described, the relative event database provides a unique data structure for allowing a computing system to efficiently generate a plurality of analysis parameters, such as the number of concurrent network connections in a data stream broadcast.

The concurrency routine 400 begins at block 401 where the data streaming server 130 retrieves a usage database from a software application server such as the data streaming server application 360 of the streaming server 130. The usage database is an event-based data set that is generated by a data streaming server application 360. As known to one of ordinary skill in the art, usage databases are common to data streaming servers and are generally used for recording the network traffic between the plurality of client computers 120 and the streaming server 130. For illustrative purposes, a representative section of a usage database is illustrated in TABLE 1.

TABLE 1

| Connection | | | Other |
|---|---|---|---|
| ID | Start Time | End Time | Data |
| 1 | 2000-01-01 00:01:20 | 2000-01-01 00:01:45 | . . . |
| 2 | 2000-01-01 00:01:30 | 2000-01-01 00:01:45 | . . . |
| 3 | 2000-01-01 00:01:40 | 2000-01-01 00:02:20 | . . . |
| 4 | 2000-01-01 00:01:45 | 2000-01-01 00:02:10 | . . . |
| 5 | 2000-01-01 00:02:00 | 2000-01-01 00:03:20 | . . . |
| 6 | 2000-01-01 00:02:20 | 2000-01-01 00:02:40 | . . . |

As shown in TABLE 1, a usage database generally comprises a list of individual records 1-6, where each record represents an event related to specific activity of the data streaming server application. More specifically, each data record stores a plurality of data attributes that indicate start and stop times of a network connection from a data stream. For example, the first record indicates that one client computer 120 connected to the streaming server 130 at 2000-01-01 00:01:20 and received a data stream of a media file until 2000-01-01 00:01:45. In addition to the start and stop times of specific network connections, each record may store a number of other data attributes, such as: a network connection ID, client computer network address, user ID, media file ID, or other like data. Although the above-described example of one usage database is shown and described, usage databases may be in any format that communicates event information related to network connection activity of a streaming server.

Once the usage database is retrieved by the streaming server 130, the concurrency routine 400 proceeds to block 403 where the system transforms the received usage database to provide a relative event database. In accordance with one embodiment, the relative event database comprises a data set that stores a plurality of records each indicating individual network events, where each record indicates an individual start time or an individual stop time. To illustrate one example of a data transformation, the six records of TABLE 1 are separated into two database tables having individual start times (TABLE 2) and individual stop times (TABLE 3).

TABLE 2
Connection Start Times

| Connection ID | Event Time |
|---|---|
| 1 | 2000-01-01 00:01:20 |
| 2 | 2000-01-01 00:01:30 |
| 3 | 2000-01-01 00:01:40 |
| 4 | 2000-01-01 00:01:45 |
| 5 | 2000-01-01 00:02:00 |
| 6 | 2000-01-01 00:02:20 |

TABLE 3
Connection End Times

| Connection ID | Event Time |
|---|---|
| 1 | 2000-01-01 00:01:45 |
| 2 | 2000-01-01 00:01:45 |
| 4 | 2000-01-01 00:02:10 |
| 3 | 200-01-01 00:02:20 |
| 6 | 2000-01-01 00:02:40 |
| 5 | 2000-01-01 00:03:20 |

As shown in TABLES 2 and 3, a data record has been created for each start and stop shown TABLE 1. As part of the illustrative process, a relative database may be generated, wherein each record of the relative database stores information related to a signal network connection event, such as an network connection, indicated by a start time, or a network disconnection, indicated by a stop time. One example of a relative event database is illustrated in TABLE 4.

TABLE 4

| | | Applied | Aggregate |
|---|---|---|---|
| Event Time | Event Type | Change | Change |
| 2000-01-01 00:01:20 | Connect | +1 | +1 |
| 2000-01-01 00:01:30 | Connect | +1 | +2 |
| 2000-01-01 00:01:40 | Connect | +1 | +3 |
| 2000-01-01 00:01:45 | Connect | +1 | +4 |
| 2000-01-01 00:01:45 | Disconnect | −1 | +3 |
| 2000-01-01 00:01:45 | Disconnect | −1 | +2 |
| 2000-01-01 00:02:00 | Connect | +1 | +3 |
| 2000-01-01 00:02:10 | Disconnect | −1 | +2 |
| 2000-01-01 00:02:20 | Connect | +1 | +3 |
| 2000-01-01 00:02:20 | Disconnect | −1 | +2 |
| 2000-01-01 00:02:40 | Disconnect | −1 | +1 |
| 2000-01-01 00:03:20 | Disconnect | −1 | 0 |

As shown in TABLE 4, the relative event database comprises a plurality of data records, where each data record indicates a single network connection event. In this illustrative embodiment, it is preferred to sort each record by the event time. Also shown in TABLE 4, the process of block 402 tracks the type of network connection event. In one embodiment, each record of the relative event database may comprise a data attribute indicating the type of network activity. In this example, a database attribute is stored to indicate if there is a network connection (“connect”) or a disconnection (“disconnect”). From the usage database of TABLE 1, a “start time” translates to a “connect,” and an “end time” translates to a “disconnect.”

The transformation process of block 402 also generates two other data attributes from the relative event database. Also shown in FIG. 4, the transformation process of block 402 generates an Applied Change and Aggregate Change value for each data record. By considering each connection event as an equal event, the system assigns an unweighted value for each event. In this example the unweighted value, also referred to as an Applied Change value, is generated by assigning a “+1” value for each “connect” event, and a “−1” value for each “disconnect” event. The Aggregate Change value is generated by adding each Applied Change value of each consecutive record. From this transformed database, the number of concurrent network connections can be readily retrieved. For example, a database query can be executed to determine the number of concurrent network connections at a specific time. As shown in TABLE 4, at a predetermined time such as 2000-01-01 00:02:01, there are three concurrent network connections.

In the calculation of the number of concurrent network connections, the method of the present invention also accommodates situations where simultaneous events occur at one given time. For example, in the calculation of the number of concurrent network connections within a time period of (t=00:00-01:45), erroneous results may arise because three events simultaneously occurred at time (t=01:45). Since two disconnections and one new connection occurred at a time (t=01:45), different values may result depending on the how many records are considered in the calculation of the number of concurrent network connections.

In one embodiment, the method of the present invention processes database records having simultaneous events by considering all of the database records that occur at or before a specific time, or before a specific end time of a user-specified predetermined time period. For instance, in the example of TABLE 4, it is preferred that the method of this embodiment consider the first six records for calculating the number of concurrent connections that occurred before a time of (t=01:45).

When calculating the number of concurrent connections in a predetermined time period it is preferred to start with an initial value for the number of network connections. The initial value is useful in certain instances because the concurrency routine 400 calculates a value relative to the number of concurrent connections at the beginning of a predetermined time period. For example, when a server is started a time of (t=0), it is preferred to start with an initial value of zero. However, in situations where the calculation of the number of concurrent connections is determined in a time period after the server has started, e.g., (t=01:00-01:45), it is desirable to have a valid initial value indicating the number of network connections at time (t=01:00). In this case, the number of concurrent connections is changed from the initial value from a period after time (t=01:00). Accurate results yield from this method of the present invention if the initial value is accurately calculated.

Given the precondition of an accurate initial value for the number of concurrent connections, the current number of network connections is equal to the initial value plus the Aggregate Change value, at any user-specified time. In a situation where the initial value is zero, the actual number of connections is equal to the Aggregate Change value. As described above, in the determination of the number of concurrent connections at a predetermined time, it is preferred to locate the last record in the database having a timestamp at or before the predetermined time. As shown in the example of TABLE 4, in a time period from 01:45 to 01:59, the correct Aggregate Change value is +2. The correct value is calculated because all records within the period where considered. However, if a database query incorrectly considered only one data record at 01:45, the method may produce an invalid value of +4.

Although the examples of TABLES 1-4 illustrate one embodiment of the process of block 402, these example tables are for visual convenience only and only represent one illustrative method for executing the data transformation. It is within the scope of the present invention to execute the transformation process of block 402 by the use of other computing methods, such as those executed by configured database calls or by the use of generating other formatted tables. More specifically, the Applied Change and Aggregate Change values may be generated from the usage database of TABLE 1 without the need to generate the data formats of TABLES 2-4. Depending on the desired result and efficiency, the storage location of each event record could be done either by traversing the table linearly, performing a binary search on an array, or by making a single query from a database.

In one alternative embodiment, the process of block 402 can also be executed by the use of only one table where sorting fields are added to identify the order of each event. For example, the first record of TABLE 1 may also contain the value of (1, 5) a new data field. This ordering represents the ordering of this record as it would appear in the sorted table, as shown in TABLE 4. In this alternative embodiment, the Aggregate Change values can be calculated once and stored in another data field or another separate database. Alternatively, the Aggregate Change values can be omitted from any database and calculated on an as-needed basis. If the Aggregate Change is to be used more than once, it is preferred that the Aggregate Change be calculated and stored into a database.

Once the data transformation of block 402 is complete, the concurrency routine 400 then proceeds to block 403 where the system of the present invention calculates a plurality of network connection parameters. Generally described, the server executes the process of block 403 to generate several network connection parameters such as the maximum, minimum, and approximate mean of a plurality of concurrent connections during any user-specified predetermined time period. Although, the process of block 403 is illustrated to occur after the determination of the number of network connections (process of block 402), the process of block 403 can be executed independent from any other calculation.

In one embodiment, the process of block 403 involves the calculation of the minimum and maximum number of network connections within a predetermined period of time. This embodiment of the present invention involves a routine that utilizes the transformed database as shown in TABLE 4. In one implementation, the minimum and maximum number of network connections are determined by a database query. More specifically, the minimum and maximum number of network connections are determined by linearly traversing the Aggregate Change fields in the database of TABLE 4. Given the database structure of TABLE 4, the database query is preferably configured to record the high and low values stored in the Aggregate Change field for each record of the database. To find a minimum and maximum number of network connections within a predetermined time period, the database query should be configured to limit the query to data records having a timestamp within the predetermined time period. It is also preferred that the database query be configured to record the high and low values found in the query of the Aggregate Change field, and store the timestamp associated with the data records having the high and low values.

Although this implementation of this embodiment involves a linear database query, the calculation of the minimum and maximum number of network connections can be carried out in other ways. For example, in one alternative implementation, a database query can be configured to select the minimum and maximum value in the “Aggregate Change” fields of the records having a timestamp within the predetermined time period. This alternative implementation returns a valid minimum and maximum value and the time at which they occurred. These return values can then be used in further data analysis, or stored in any other computer storage medium.

In the calculation of the minimum and maximum number of network connections, the method of the present invention processes all database records having timestamps within the given predetermined period to accommodate simultaneous events. In one example, a linear traversal or selection query seeking the maximum of the aggregate change value would return the record with a time of 01:45 and change of +4. Since the subsequent database records indicate that the true value at 01:45 was in fact only +2, this would be incorrect. The true maximum value is in fact +3, which is achieved at the timestamps of 01:40 and 02:00. Therefore, the database query methods for calculating the minimum and maximum values must be implemented to consider only the last true Aggregate Change value to provide an accurate value and accommodate records of simultaneous events.

The process for generating the minimum and maximum values is also shown in the pseudo programming code of APPENDIX A. With reference to the pseudo programming code of APPENDIX A, the MIN and MAX variables are given a null value before the program is executed. Once executed, the program is run for a predetermined period of time, e.g., at an interval between a user-specified start and end time. By the use of similar programming code, the output of the computer code can be configured to produce a data table or chart including: the number of connections in each interval (EDGE), the maximum number of connections in each interval (MAX), and the minimum number of connections in each interval (MIN).

Referring again to FIG. 4, another embodiment of the process of block 403 will now be described. This embodiment of the process of block 403 involves the calculation of an approximate mean for the number of network connections in a predetermined time period. According to one aspect of the invention, the calculation of the approximate mean involves the generation of an interval-based storage model. In addition to providing a database structure for facilitating the calculation of the approximate mean, the interval-based storage model also provides an efficient data format for storing the data records describing to network connection activity. In other words, the interval-based storage model is a more economical way of storing network activity information by dividing the time span into uniform intervals instead of recording each event. This format provides a particular advantage in event-based databases having thousands of records that will consume a large volume of storage space. One illustrative example of the interval-based storage model is shown in TABLE 6.

TABLE 6

| Measurement Time | Aggregate Change |
|---|---|
| 2000-01-01 00:00:00 | 0 |
| 2000-01-01 00:00:30 | 0 |
| 2000-01-01 00:01:00 | 0 |
| 2000-01-01 00:01:30 | +2 |
| 2000-01-01 00:02:00 | +3 |
| 2000-01-01 00:02:30 | +2 |
| 2000-01-01 00:03:00 | +1 |
| 2000-01-01 00:03:30 | 0 |

As shown in TABLE 6, the interval-based storage model involves the storage of a plurality of data records, where each record stores an Aggregate Change data field. In addition, the interval-based storage model may also include other data fields such as the Measurement Time field. The data stored in the Measurement Time field indicates the time period in which the Aggregate Change is measured. Other data fields may be added to each record of the interval-based storage model to accommodate other features, such as storing a plurality of server ID's for providing a filter to determine the number of network connections provided by one server.

In one embodiment, the generation of the interval-based storage model involves the use of a database query on the relative event database of TABLE 4. As described above, once the relative event database of FIG. 4 is generated, a database query can be configured to determine the number of network connections within a predetermined time period. Accordingly, the generation of the interval-based storage model would involve a series of database queries configured to analyze records having timestamps with the desired time interval. The result of each database query would provide the Aggregate Change value for each record in the interval-based storage database. In one illustrative example, the representative database of TABLE 6 is the result of a series of database queries performed on the event database of FIG. 4. In the implementation of this illustrative example, each database query is configured to read records within 30 second intervals and configured to store a summation of the Aggregate Change values in the consecutive data records of the interval-based database.

According to one aspect of the invention, the interval-based database provides a more efficient storage format for network usage information. The interval-based storage database of this embodiment provides improved storage efficiency, especially in situations where a streaming server has surges in the number of multicast data streams. Large surges in the number of multicast data streams occur in broadcasts such as the case of a media presentation, where a large number of viewers connect to the server at a time near the beginning of the presentation, remain connected throughout the presentation, and then simultaneously disconnect at a time near the end of the presentation.

To improve the storage efficiency of the database, the interval-based storage database is modified by eliminating sequential rows that have the same Aggregate Change value. In one illustrative example, with reference to the database of TABLE 6, the second and third data records having an Aggregate Change value of 0 are eliminated. The elimination of these records is carried out with no loss of information since the database still accurately indicates that a value of 0 persisted from timestamp 00:00 to 01:30. According to this embodiment of the present invention, although the first data record contains the same Aggregate Change value as the second record, it is preferred that the first record is not deleted from the database. Keeping the first record in the database allows for an accurate determination of the next changed Aggregate Change value.

By the use of the interval-based storage model of TABLE 6, one method of the present invention provides for the calculation of an approximate mean for a plurality of concurrent network connections analyzed within a predetermined period of time. In one embodiment, the approximate mean is calculated by averaging the Aggregate Change value of the data records stored in the interval-based storage database. This method provides a reasonable approximate mean by only considering the unweighted mean of the Aggregate Change value at each interval. As applied to the example database of FIG. 6, the calculated mean is (2+3+2+1)/7, or 1.143 concurrent connections.

In comparison, a true mean would require taking a weighted sum of the number of connections, multiplied by the duration of the connection, and dividing by the number of seconds in the sample. In one example, if a sample lasts for 200 seconds, during which there are zero connections for 80 seconds, 1 connection for 50 seconds, 2 connections for 55 seconds, and 3 connections for 15 seconds. The true mean is therefore ((80*0)+(50*1)+(55*2)+(15*3))/200, or a mean of 1.025 concurrent connections. This method operates to provide an accurate mean; however, for efficiency and cost purposes, it is preferred to utilize the embodiment that produces the approximate mean.

In yet another embodiment of the present invention, one method of the present invention involves a process where the server 130 differentiates multiple types of broadcasts to calculate server-specific and/or user-specific network connection parameters. More specifically this embodiment provides values for the minimum, maximum, approximate mean, and number of concurrent network connections for individual broadcasts and/or broadcasts originating at a specified server.

In this embodiment, the method utilizes a database format similar to the example of TABLE 4. More specifically, the database of TABLE 4 is also configured to store a server ID in each record. The addition of the server ID in each record allows the server to filter database records that are analyzed in the above-described methods. Accordingly, the server has the ability to calculate the above-described connection parameters for one or more specified servers. In another embodiment, the database of TABLE 4 is configured to store an owner ID associated with a content provider transmitting the streaming data. The addition of the owner ID allows the database query to filter database records associated with specific owners or content providers. A representative example of a database of this embodiment is shown in TABLE 6.

TABLE 6

| Connec- | | | Serv- | |
|---|---|---|---|---|
| tion ID | Start Time | End Time | er ID | Owner |
| 1 | 2000-01-01 00:11:59 | 2000-01-01 00:01:45 | 1 | 3423 |
| 2 | 2000-01-01 00:12:01 | 2000-01-01 00:01:45 | 2 | 3411 |
| 3 | 2000-01-01 00:12:02 | 2000-01-01 00:02:20 | 2 | 4324 |
| 4 | 2000-01-01 00:01:45 | 2000-01-01 00:02:10 | 3 | 4324 |
| 5 | 2000-01-01 00:02:00 | 2000-01-01 00:03:20 | 1 | 5430 |
| 6 | 2000-01-01 00:02:20 | 2000-01-01 00:02:40 | 2 | 4430 |

As illustrated in the examples above, each of the connection parameters can be determined by the use of a database query having a filter for selectively analyzing server or owner specified data records. In an example of involving the database of TABLE 6, if a user desires to only count the number of connections from a server having a Server ID value of 2, the system will only read the second, third and sixth record before the merged database is created and sorted.

While the preferred embodiment of the invention has been illustrated and described, it will be appreciated that various changes can be made therein without departing from the spirit and scope of the invention.

APPENDIX A
PSEUDO PROGRAMMING CODE:
// Variables
MAX; // variable for storing the maximum number of connections in a period.
MIN; // variable for storing the minimum number of connections.
EDGE; //variable for keeping track of the number of connections at the end in the

period.

PER_{—TIME // variable for storing the time period intervals, initially equal to the time}

of the measured duration.

REC_{—TIME // variable for storing the value from the Aggregate Change field of the}

data record (as shown above).

INTERVAL_{—VAL // time variable entered by the user - a time period less than the}

duration of the measured duration.

//initialization PER_{—TIME = start time of the beginning of the period of time to}

measure (e.g., 12:00).

PER_{—TIME = PER}_{—TIME + INTERVAL}_{—VAL}
// for example INTERVAL_{—VAL = 5 min. thus, PER}_{—TIME is now 12:05.}
While (Not at the end of the database of records) {

Retrieve one record from the database
If ( REC_{—TIME > PER}_{—TIME) {}
store (EDGE, MAX, MIN) // where these values are stored into a table of

measurements for every // time period, INTERVAL_{—VAL}

EDGE = MAX = MIN;
PER_{—TIME += INTERVAL}_{—VAL;}
}

EDGE = EDGE + (value read from the “Applied Change” field);
If EDGE < MIN
MIN = EDGE;
If EDGE > MAX
MAX = EDGE;
} //end while

The embodiments of the invention in which an exclusive property or privilege is claimed are defined as follows:

1. A method for determining a number of concurrent network connections related to broadcast data transfers, wherein the method comprises:
receiving a plurality of data records, wherein individual records of the plurality of data records store data attributes that describe a connect time and a disconnect time of a network connection;
generating an aggregate change value from the data attributes stored in the plurality of data records; and
calculating the number of concurrent network connections within a predetermined time period, wherein the number of concurrent network connections is based on the aggregate change value of individual records having data attributes within the predetermined time period.

2. The method of claim 1, further comprising:
generating a plurality of applied change values from the data attributes stored in the plurality of data records, wherein specific individual applied change values are assigned a first value for data attributes that describe a connect time, and wherein other individual applied change values are assigned a second value for data attributes that describe a disconnect time; and
generating the aggregate change value for individual records of the plurality of data records based on the applied change value, wherein the aggregate change value is incremented for aggregate change values having an assigned first value, and wherein the aggregate change value is decremented for aggregate change values having an assigned second value.

3. The method of claim 1, further comprising, storing the plurality of aggregate change value in individual data records of the plurality of data records.

4. The method of claim 1, further comprising, storing the aggregate change value in individual data records of the plurality of data records.

5. The method of claim 1, wherein calculating the number of concurrent network connections within a predetermined time period further comprises, considering all data records having simultaneous timestamps that are within the predetermined time period.

6. The method of claim 1, wherein the generation of the plurality of applied change values are from a database query, wherein the database query is configured to increment subsequent applied change values if individual data attributes are found to describe one connect time, and wherein the database query is configured to decrement subsequent applied change values if individual data attributes are found to describe one disconnect time.

7. The method of claim 1, further comprising:
forming a merged database of a plurality of database records, wherein individual database records of the plurality of database records store the generated aggregate change value and data attributes that describe a connect time and a disconnect time of a network connection; and
storing the merged database in a computer-readable medium.

8. The method of claim 1, wherein the calculation of the aggregate change value is based on the individual database records having a predetermined server identifier.

9. The method of claim 1, wherein the calculation of the aggregate change value is based on the individual database records having a predetermined media identifier.

10. A system for determining a number of concurrent network connections related to broadcast data transfers, the system comprising:
a means for receiving a plurality of data records, wherein individual records of the plurality of data records store data attributes that describe a connect time and a disconnect time of a network connection;
a means for generating an aggregate change value from the data attributes stored in the plurality of data records; and
a means for calculating the number of concurrent network connections within a predetermined time period, wherein the number of concurrent network connections is based on the aggregate change value of individual records having data attributes within the predetermined time period.

11. A computer-readable medium for storing computer code, wherein the programming code, which when executed, performs the method of:
receiving a plurality of data records, wherein individual records of the plurality of data records store data attributes that describe a connect time and a disconnect time of a network connection;
generating an aggregate change value from the data attributes stored in the plurality of data records; and
calculating a number of concurrent network connections within a predetermined time period, wherein the number of concurrent network connections is based on the aggregate change value of individual records having data attributes within the predetermined time period.

12. A method for determining an approximate mean of a plurality of concurrent network connections related to broadcast data transfers, wherein the method comprises:
receiving a plurality of data records, wherein individual records of the plurality of data records store data attributes that describe a connect time and a disconnect time of a network connection;
forming a database of the plurality of database records, wherein individual database records of the plurality of database records store data attributes representing timestamps having relatively consistent time intervals between the timestamps of each record, and wherein individual database records of the plurality of database records store an aggregate change value calculated from a summation of values that represent the data attributes stored in the plurality of data records; and
calculating the approximate mean of the plurality of concurrent network connections measured within a predetermined time period, wherein the approximate mean is based on an averaged summation of the aggregate change values.

13. The method of claim 12, further comprising, storing the plurality of aggregate change value in individual database records.

14. The method of claim 12, further comprising, removing consecutive data records having equal aggregate change values.

15. The method of claim 12, wherein the calculation of the aggregate change value is based on the individual database records having a predetermined server identifier.

16. The method of claim 12, wherein the calculation of the aggregate change value is based on the individual database records having a predetermined media identifier.

17. A system for determining an approximate mean of a plurality of concurrent network connections related to broadcast data transfers, the system comprising:
a means for receiving a plurality of data records, wherein individual records of the plurality of data records store data attributes that describe a connect time and a disconnect time of a network connection;
a means for forming a database of the plurality of database records, wherein individual database records of the plurality of database records store data attributes representing timestamps having relatively consistent time intervals between the timestamps of each record, and wherein individual database records of the plurality of database records store an aggregate change value calculated from a summation of values that represent the data attributes stored in the plurality of data records; and
a means for calculating the approximate mean of the plurality of concurrent network connections measured within a predetermined time period, wherein the approximate mean is based on an averaged summation of the aggregate change values.

18. A computer-readable medium for storing computer code, wherein the programming code, which when executed, performs the method of:
receiving a plurality of data records, wherein individual records of the plurality of data records store data attributes that describe a connect time and a disconnect time of a network connection;
forming a database of the plurality of database records, wherein individual database records of the plurality of database records store data attributes representing timestamps having relatively consistent time intervals between the timestamps of each record, and wherein individual database records of the plurality of database records store an aggregate change value calculated from a summation of values that represent the data attributes stored in the plurality of data records; and
calculating an approximate mean of the plurality of concurrent network connections measured within a predetermined time period, wherein the approximate mean is based on an averaged summation of the aggregate change values.

19. A method for determining a minimum number of concurrent network connections related to broadcast data transfers, wherein the method comprises:
receiving a plurality of data records, wherein individual records of the plurality of data records store data attributes that describe a connect time and a disconnect time of a network connection;
calculating an aggregate change value from the data attributes stored in the plurality of data records, wherein the calculation of the aggregate change value is based on a summation of values that represent the data attributes stored in the plurality of data records; and
calculating the minimum number of concurrent network connections within a predetermined time period, wherein the number of concurrent network connections is based on the lowest aggregate change value of individual records having data attributes within the predetermined time period.

20. A method for determining a maximum number of concurrent network connections related to broadcast data transfers, wherein the method comprises:
receiving a plurality of data records, wherein individual records of the plurality of data records store data attributes that describe a connect time and a disconnect time of a network connection;
calculating an aggregate change value from the data attributes stored in the plurality of data records, wherein the calculation of the aggregate change value is based on a summation of values that represent the data attributes stored in the plurality of data records; and
calculating the maximum number of concurrent network connections within a predetermined time period, wherein the number of concurrent network connections is based on the highest aggregate change value of individual records having data attributes within the predetermined time period.
